(19) United States
(12) Patent Application Publication
(10) Pub. No.: US 2008/0018822 A1
(43) Pub. Date: Jan. 24, 2008

(54) Display Device

(75) Inventor: Norio Yamamoto, Tottori-shi (JP)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignees: SANYO ELECTRIC CO., LTD., Moriguchi City, Osaka (JP); TOTTORI SANYO ELECTRIC CO., LTD., Tottori-Shi, Tottori (JP)

(21) Appl. No.: 10/593,638

(22) PCT Filed: Mar. 23, 2005
(86) PCT No.: PCT/JP05/05204

§ 371 Date: Jun. 25, 2007

(30) Foreign Application Priority Data
Mar. 29, 2004 (JP) 2004-096096

(51) Int. Cl. G02F 1/1333

(52) U.S. Cl. 349/58; 439/620.01

(57) ABSTRACT

A display device has a flat box-shaped cabinet that is open in the upper face. The cabinet accommodates a liquid crystal display panel and holds it in place. The inside of the cabinet is divided into two areas. Of these two areas, one is an area in which a first circuit board, the fitting of which is compulsory, is fitted, and the other is an area in which a second circuit board, the fitting of which is optional, is fitted. On a rear lid of the liquid crystal display panel, synthetic resin fitting bases are formed, and hooks are formed thereon in the boundary between the two areas. When the second circuit board is not fitted, the hooks are used for attaching a small shield cover that covers the first circuit board, and, when the second circuit board is fitted, they are used for locking the second circuit board in place and preventing it from coming out of position.

### TECHNICAL FIELD

The present invention relates to a display device formed by fitting a circuit board inside a cabinet having a display member at the front side thereof and an opening at the back side thereof, and then covering the opening of the cabinet with a shield cover.

### BACKGROUND ART

Display devices, such as liquid crystal display devices, that use a thin display panel often adopt a structure in which the display panel and a circuit board for driving it are stacked within a thin cabinet. In these display devices, a cabinet is often made common so as to make it possible to offer different models by replacing only a circuit board with another. Patent Publication 1 discloses an example of, not a display device, but an electronic device that makes it possible to offer different models by replacing only a circuit board with another.

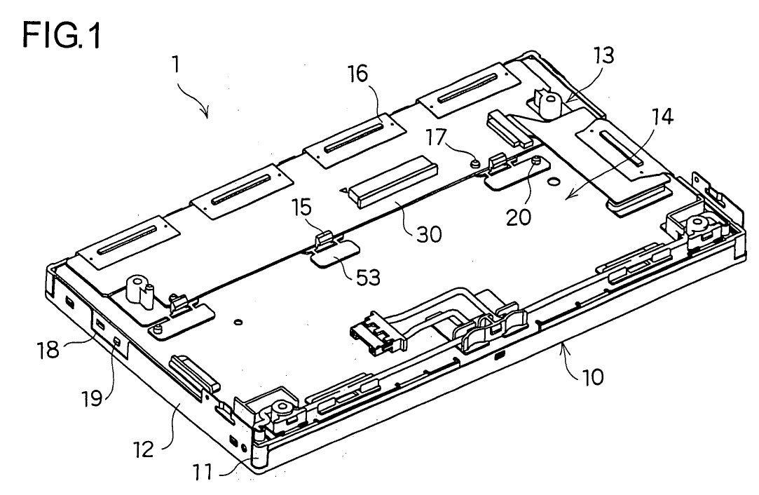

### Patent Publication 1: JP-A-2002-366257 (page 2, FIG. 1)

### DISCLOSURE OF THE INVENTION

### Problems to be Solved by the Invention

Different models of display device in which a cabinet is made common are obtained by replacing a circuit board provided inside the cabinet with another. The circuit board is replaced by the following two methods. The first method is to divide the circuit board into a first circuit board and a second circuit board. The fitting of the first circuit board is compulsory and the fitting of the second circuit board is optional. In this method, a different model of display device is obtained by fitting the second circuit board. The second method is to selectively fit one of first and second circuit boards having different sizes, thereby obtaining a different model of display device. An object of the present invention is to provide a display device in which the structure is so designed as to permit easy assembly when the methods described above are employed to offer different models of display device.

### Means for Solving the Problem

To achieve the above object, according to one aspect of the present invention, a display device is provided with: a flat box-shaped cabinet having a display member at the front side thereof and an opening at the back side thereof; a circuit board that is fitted to the cabinet or a member accommodated inside the cabinet; and a shield cover for covering the opening of the cabinet after the circuit board is fitted. In this display device, the circuit board includes a first circuit board, the fitting of which is compulsory, and a second circuit board, the fitting of which is optional, an area for the first circuit board and an area for the second circuit board are provided inside the cabinet so as to be adjacent to each other, a hook is formed in the boundary between these areas, and, when the second circuit board is not fitted, the hook is used for attaching a small shield cover that covers the first circuit board, and, when the second circuit board is fitted, the hook is used for locking the second circuit board in place.

With this structure, the hook is formed in the boundary between the area for the first circuit board and the area for the second circuit board, making it possible to neatly fit the circuit boards in their respective areas. When the second circuit board is not fitted, this hook is used for attaching the small shield cover that covers the first circuit board, eliminating the need to prepare extra fixing means for fixing the small shield cover. The same hook is used, when the second circuit board is fitted, for locking the second circuit board in place, making it easy to fit the second circuit board. That is, by using the hook versatilely, it is possible to produce two different models of display device with a reduced number of parts.

According to another aspect of the present invention, a display device is provided with: a flat box-shaped cabinet having a display member at the front side thereof and an opening at the back side thereof; a circuit board that is fitted to the cabinet or a member accommodated inside the cabinet; and a shield cover for covering the opening of the cabinet after the circuit board is fitted. In this display device, either a first circuit board or a second circuit board, the former is smaller than the latter, is selectively fitted as the circuit board, and, inside the cabinet, there is provided a hook that is used, when the first circuit board is fitted, for attaching a small shield cover that covers the first circuit board, and, when the second circuit board is fitted, for locking the second circuit board in place.

With this structure, the hook formed inside the cabinet is used, when the smaller first circuit board is fitted, for attaching the small shield cover that covers the first circuit board, eliminating the need to prepare extra fixing means for fixing the small shield cover. When the larger second circuit board is fitted, the same hook is used for locking the second circuit board in place, making it easy to fit the second circuit board. That is, by using the hook versatilely, it is possible to produce two different models of display device with a reduced number of parts.

According to the present invention, in the display device structured as described above, display means is a liquid crystal display panel, the first circuit board is a driving circuit board, and the second circuit board is an inverter circuit board.

With this structure, since the display means is a liquid crystal display panel, the first circuit board is a driving circuit board, and the second circuit board is an inverter circuit board, it is possible to easily produce a liquid crystal display device that needs an inverter and a liquid crystal display device that needs no inverter by using the same cabinet.

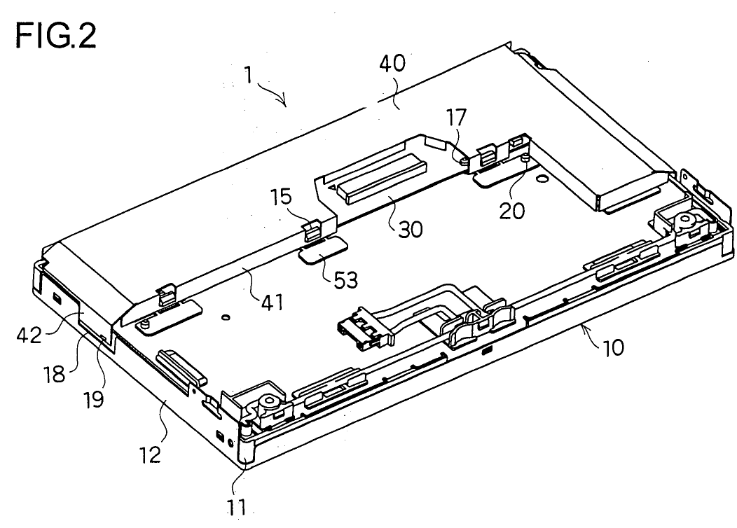

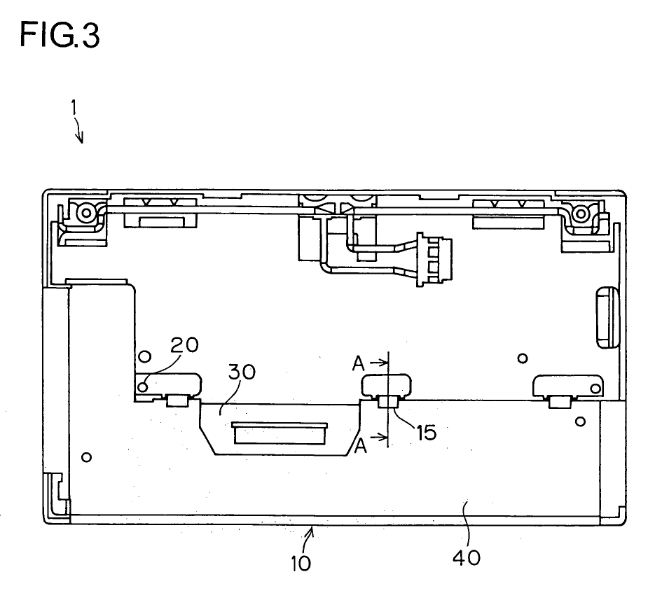

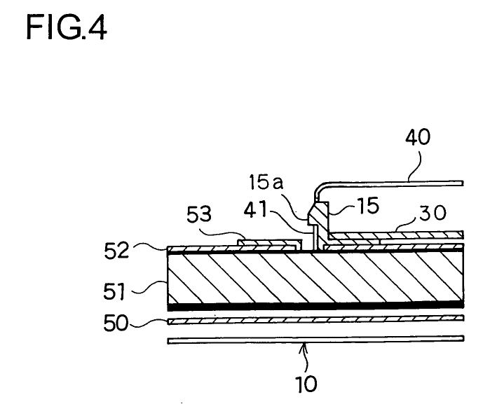

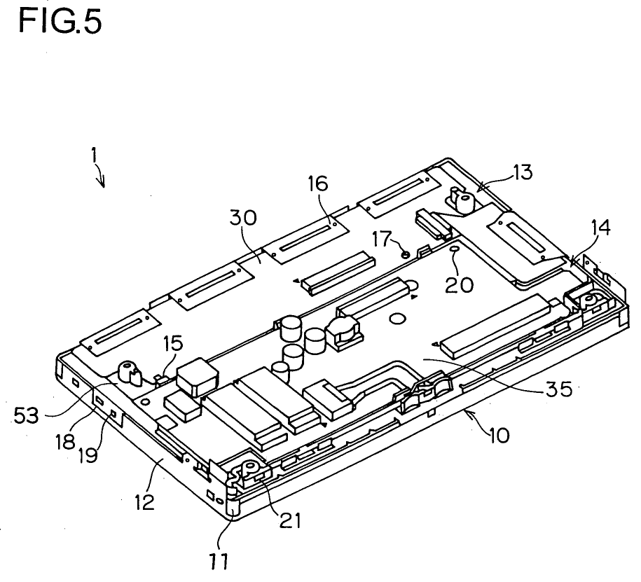

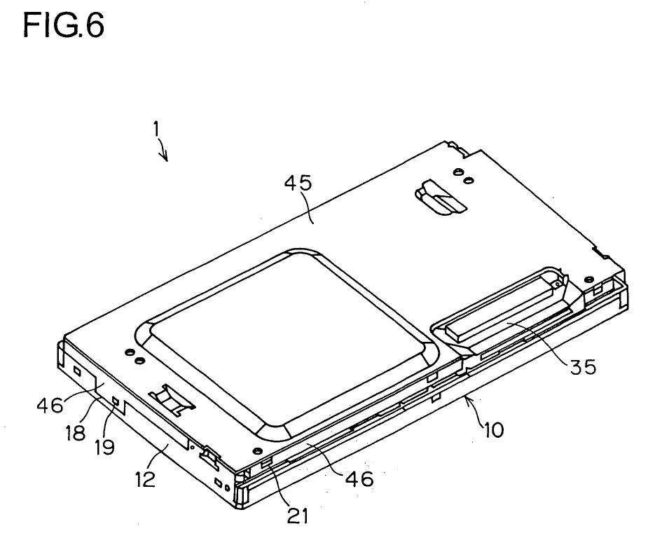

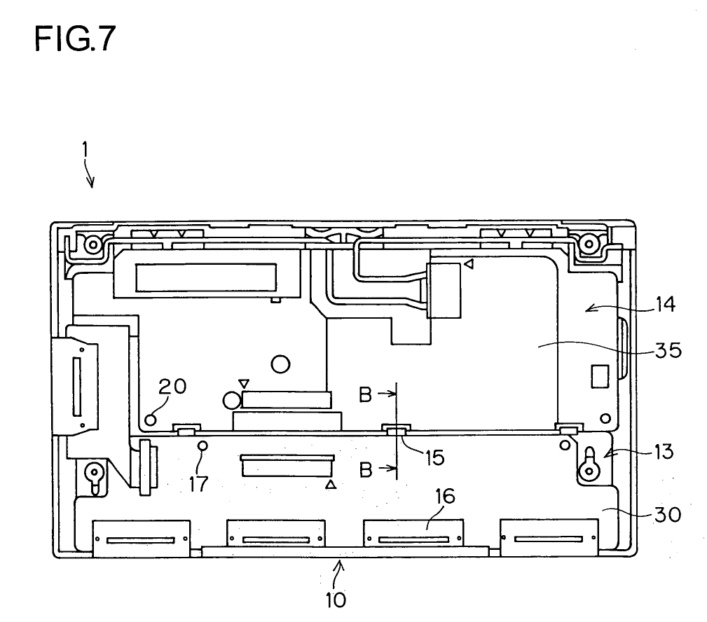

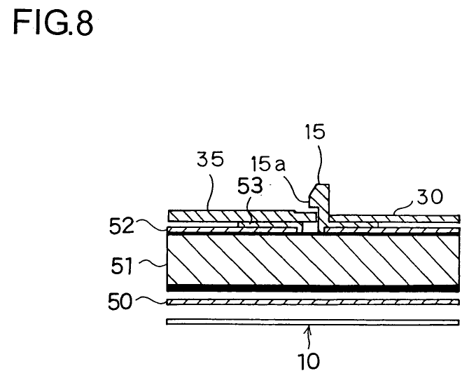

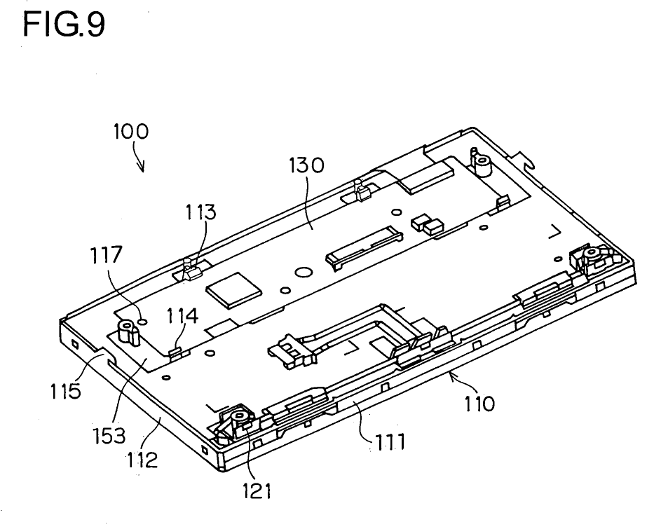

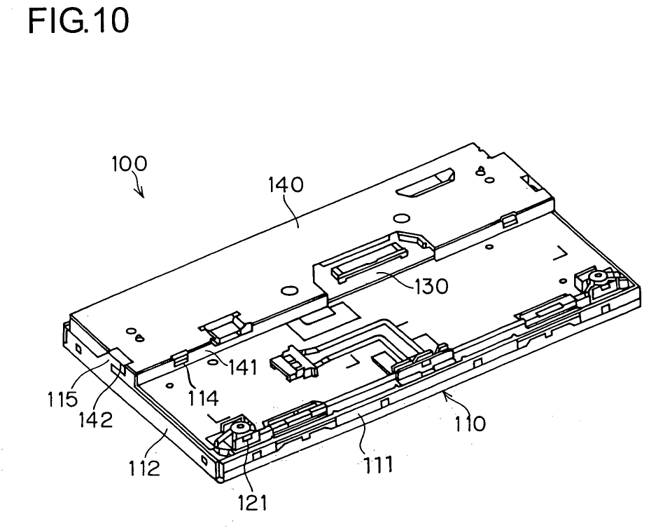

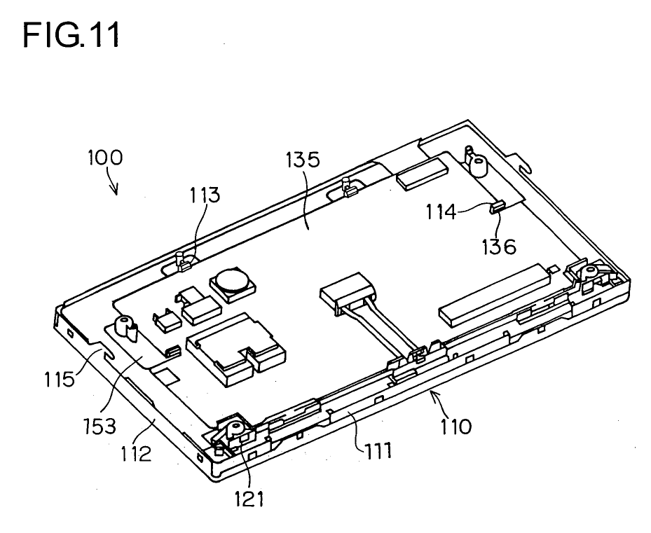

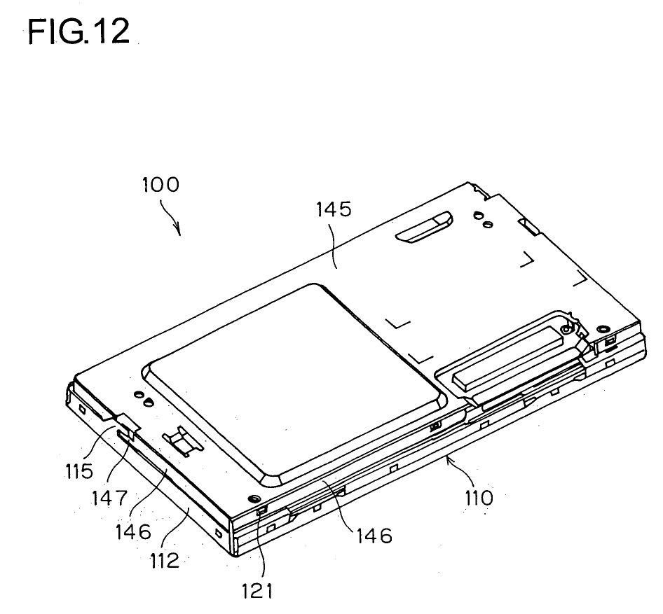

### BRIEF DESCRIPTION OF DRAWINGS

[FIG. 1] A perspective view showing the state in which only the first circuit board is fitted inside the cabinet of the display device of a first embodiment of the present invention.

[FIG. 2] A perspective view showing the state in which the small shield cover is attached to the display device shown in FIG. 1.

[FIG. 3] A plan view of the state shown in FIG. 2.

[FIG. 4] A partially sectional view taken along line A-A shown in FIG. 3.

[FIG. 5] A perspective view showing the state in which both the first and second circuit boards are fitted inside the cabinet of the display device of the first embodiment of the present invention.

[FIG. 6] A perspective view showing the state in which the large shield cover is attached to the display device shown in FIG. 5.

[FIG. 7] A plan view of the state shown in FIG. 5.

[FIG. 8] A partially sectional view taken along line B-B shown in FIG. 7.

[FIG. 9] A perspective view showing the state in which the first circuit board is fitted inside the cabinet of the display device of a second embodiment of the present invention.

[FIG. 10] A perspective view showing the state in which the small shield cover is attached to the display device shown in FIG. 9.

[FIG. 11] A perspective view showing the state in which the second circuit board is fitted inside the cabinet of the display device of the second embodiment of the present invention.

[FIG. 12] A perspective view showing the state in which the large shield cover is attached to the display device shown in FIG. 11.

### LIST OF REFERENCE SYMBOLS

1 display device
10 cabinet
11 frame
12 outer covering
13 area for first circuit board
14 area for second circuit board
15 hook
17,20 fitting pin
30 first circuit board
35 second circuit board
40 small shield cover
45 large shield cover
50 liquid crystal display panel
52 rear lid
53 fitting base
100 display device
110 cabinet
111 frame
112 outer covering
114 hook
117 fitting pin
130 first circuit board
135 second circuit board
140 small shield cover
145 large shield cover
153 fitting base

### BEST MODE FOR CARRYING OUT THE INVENTION

Hereinafter, embodiments of the present invention will be described with reference to the figures.

A first embodiment is shown in FIGS. 1 to 8. FIG. 1 is a perspective view showing the state in which only the first circuit board is fitted inside the cabinet of the display device. FIG. 2 is a perspective view showing the state in which the small shield cover attached to the display device shown in FIG. 1. FIG. 3 is a plan view of the state shown in FIG. 2. FIG. 4 is a partially sectional view taken along line A-A shown in FIG. 3. FIG. 5 is a perspective view showing the state in which both the first and second circuit boards are fitted inside the cabinet of the display device. FIG. 6 is a perspective view showing the state in which the large shield cover is attached to the display device shown in FIG. 5. FIG. 7 is a plan view of the state shown in FIG. 5. FIG. 8 is a partially sectional view taken along line B-B shown in FIG. 7.

A liquid crystal display member of a car navigation system is shown as a display device 1. The display device 1 has a flat box-shaped cabinet 10 which in plan view is rectangular. The cabinet 10 is laid with the side thereof having a liquid crystal display window facing down. That is, a face facing upward in the figures faces downward when actually used. For the sake of convenience, a face facing upward in the figures is defined as an “upper face” of the cabinet 10.

The cabinet 10 is formed by combining an injection-molded frame 11 made of synthetic resin with an outer covering 12 made of stamped sheet metal, and is completely open in the upper face. The cabinet 10 accommodates a liquid crystal display panel 50 shown in FIG. 4, and holds it in place. The liquid crystal display panel 50 has, behind a display surface thereof, a back light 51 and a rear lid 52 made of sheet metal.

The inside of the cabinet 10 is divided into two adjacent areas by drawing a dividing line parallel with the longer sides of the rectangle. Of these two areas, one is an area 13 in which a first circuit board 30 is fitted, and the other is an area 14 in which a second circuit board 35 (see FIGS. 5 to 8) is fitted. At one edge of the first circuit board 30, there are provided four TCPs (tape carrier packages) 16 connected to the first circuit board 30. Since the first circuit board 30 is a driving circuit board for the liquid crystal display panel 50 and is essential to achieve the function of the display device 1, the fitting of the first circuit board 30 is compulsory. On the other hand, since the second circuit board 35 is an inverter circuit board for the liquid crystal display panel 50 that adds an optional feature (an inverter), it is possible to ship the display device 1 without the second circuit board 35 or ship it with the second circuit board 35 as a different model.

In the boundary between the areas 13 and 14, hooks 15 are formed. On the rear lid 52 of the liquid crystal display panel 50, synthetic resin fitting bases 53 are formed in places by so-called outsert molding. The hooks 15 are each integrated with one of the fitting bases 53. As shown in FIG. 4, the hooks 15 each have an engaging projection 15a on the side of the area 14 and a perpendicular plane on the side of the area 13. A plurality of (in the first embodiment, three) hooks 15 are arranged at appropriate intervals in the boundary between the areas 13 and 14. Incidentally, some fitting bases 53 have a fitting pin 17 formed therein for fixing the first circuit board 30 or a fitting pin 20 formed therein for fixing the second circuit board 35.

The first circuit board 30 is fitted as follows. The edge of the first circuit board 30 to which the TCPs 16 are connected is aligned with a longer side edge portion of the cabinet 10, and then the holes formed in the first circuit board 30 in positions corresponding to the fitting pins 17 are made to make contact with the fitting pins 17. The first circuit board 30 is then pressed down with the holes kept in contact with the fitting pins 17, whereby the fitting pins 17 are snapped in the holes of the first circuit board 30 as shown in FIG. 1. This is the end of the fitting of the first circuit board 30.

When the display device 1 is shipped with only the first circuit board 30 fitted thereto, a small shield cover 40 that covers only the first circuit board 30 is attached as shown in FIG. 2. The small shield cover 40 is made of stamped sheet metal, and has hung projection 41 that runs onto the boundary between the areas 13 and 14 and hung projections 42 that run onto the side faces of the cabinet 10. A plurality of hung projections 42 are provided in such a way that the cabinet 10 is surrounded thereby on three sides. The outer covering 12 has notches 18 that receive the hung projections 42. On the side faces of the frame 11, in parts exposed through the notches 18, engaging projections 19 are formed.

In the small shield cover 40, the hung projection 41 has holes corresponding to the engaging projections 15a of the hooks 15, and the hung projections 42 each have a hole corresponding to the engaging projection 19 in the notch 18. When the small shield cover 40 is put on the cabinet 10 and then pressure is applied thereon, the elasticity of the sheet metal makes the hung projection 41 and the hung projections 42 elastically engaged with the engaging projections 15a of the hooks 15 and the engaging projections 19, respectively. This is the end of the attachment of the small shield cover 40.

When the display device 1 is shipped not only with the first circuit board 30 but also with the second circuit board 35 fitted thereto, the first circuit board 30 is first fitted thereto in such a manner as described above. Then, one edge of the second circuit board 35 is engaged with the engaging projections 15a of the hooks 15, and the holes formed therein in positions corresponding to the fitting pins 20 are made to make contact with the fitting pins 20. The second circuit board 35 is then pressed down with the holes kept in contact with the fitting pins 20, whereby the fitting pins 20 are snapped in the holes of the second circuit board 35 as shown in FIG. 5. This is the end of the fitting of the second circuit board 35.

After fitting, the second circuit board 35 may tend to come out of position due to vibrations, for example. On the other hand, the fit of each fitting pin 20 is made loose when the once-fitted circuit board is detached for repairs, for example, making the second circuit board 35 tend to come out of position. Such a tendency is curbed by the engaging projection 15a that locks the edge of the second circuit board 35. That is, the hook 15 has the function of preventing such tendency by locking the second circuit board 35 in place.

After the second circuit board 35 is fitted, the opening in the upper face of the cabinet 10 is completely covered with a large shield cover 45 as shown in FIG. 6. The large shield cover 45 is made of stamped sheet metal, and has, at the edge thereof, a plurality of hung projections 46 formed in such a way that the cabinet 10 is surrounded thereby. Of these hung projections 46, some are combined with the engaging projections 19 in place of the hung projections 42 of the small shield cover 40, and the others are combined with engaging projections 21 formed in the region of the frame 11 that is not covered with the small shield cover 40, and both have holes to be engaged with the engaging projections. When the large shield cover 45 is put on the cabinet 10 and then pressure is applied thereon, the elasticity of the sheet metal makes the hung projections 46 elastically engaged with the engaging projections 19 and 21. This is the end of the attachment of the large shield cover 45.

In the embodiment described above, one first circuit board 30 and one second circuit board 35 are used; however, it is also possible to use a plurality of first circuit boards 30, a plurality of second circuit boards 35, or a plurality of first circuit boards 30 and a plurality of second circuit boards 35. All that is required is that the area for the first circuit board 30 and the area for the second circuit board 35 are arranged in the same plane, and the hook 15 is formed in the boundary between them.

This embodiment deals with a case where a linear boundary lies between the areas 13 and 14. The reason is that the line along which the first circuit board 30 and the second circuit board 35 abut each other is linear. In a case where the line along which the first circuit board 30 and the second circuit board 35 abut each other is not linear but irregular, the boundary between the areas 13 and 14 is changed to an irregular one accordingly.

Next, a second embodiment of the present invention will be described with reference to FIGS. 9 to 12. FIG. 9 is a perspective view showing the state in which the first circuit board is fitted inside the cabinet of the display device. FIG. 10 is a perspective view showing the state in which the small shield cover is attached to the display device shown in FIG. 9. FIG. 11 is a perspective view showing the state in which the second circuit board is fitted inside the cabinet of the display device. FIG. 12 is a perspective view showing the state in which the large shield cover is attached to the display device shown in FIG. 11.

A display device 100 has a flat box-shaped cabinet 110 which in plan view is rectangular. As is the case of the cabinet 10 of the first embodiment, the cabinet 110 is formed by combining an injection-molded frame 111 made of synthetic resin with an outer covering 112 made of stamped sheet metal, and is completely open in the upper face. The “upper face” is defined in the same manner as in the first embodiment.

The cabinet 110 accommodates a liquid crystal display panel similar to the liquid crystal display panel 50 of the first embodiment, and holds it in place. On a rear lid thereof, synthetic resin fitting bases 153 are formed in places by outsert molding, and hooks are formed thereon so as to protrude therefrom. Of these hooks, one is a first hook 113 formed near one longer side of the cabinet 110, and the other is a second hook 114 formed rather close to middle of the cabinet 110. The hooks 113, of which there are two, are arranged in a line parallel to the longer sides of the cabinet 110, and the hooks 114, of which there are two, are arranged in a line parallel to the longer sides of the cabinet 110. The hooks 113 and 114 are similar in shape to the hook 15 of the first embodiment, and each have an engaging projection on the side facing to the middle of the cabinet 110 and a perpendicular plane on the opposite side.

Inside the cabinet 110, either a first circuit board 130 (FIGS. 9 and 10) or a second circuit board 135 (FIGS. 11 and 12) is selectively fitted. Of these circuit boards, the smaller one is the first circuit board 130 whose shorter side width is approximately the same as the spacing between the line along which the hooks 113 are arranged and the line along which the hooks 114 are arranged, and the larger one is the second circuit board 135 having notches 136 each formed in a position away from one longer side edge by a shorter side width of the first circuit board 130 for receiving the hook 114. The first circuit board 130 is a driving circuit board for the liquid crystal display panel, and the second circuit board 135 is an inverter circuit board for the liquid crystal display panel. The inverter circuit board built as the second circuit board 135 differs from the second circuit board 35 of the first embodiment in that it not only adds an inverter, but also serves as a driving circuit board.

The first circuit board 130 is fitted as follows. First, one edge of the first circuit board 130 is made to make contact with the hooks 113, whereby it is engaged with the engaging projections of the hooks 113, and the other edge thereof is made to make contact with the perpendicular planes of the hooks 114. When the edge kept in contact with the hooks 114 is pressed down, fitting pins 117 formed in the fitting bases 153 are snapped in corresponding holes formed in the first circuit board 130 as shown in FIG. 9. This is the end of the fitting of the first circuit board 130.

When the display device 100 is shipped with only the first circuit board 130 fitted thereto, a small shield cover 140 that covers only the first circuit board 130 is attached as shown in FIG. 10. The small shield cover 140 is made of stamped sheet metal, and has a hung projection 141 that runs downward along the engaging projection side of the hook 114 and hung projections that run onto the side faces of the cabinet 110. Of the hung projections that run onto the side faces of the cabinet 110, the hung projections 142 formed in the shorter sides of the cabinet 110 are made in the shape of a hook so as to be engaged with hooks 115 formed in the outer covering 112. When the small shield cover 140 is put on the cabinet 110 and the pressure is applied thereon, the elasticity of the sheet metal makes the hung projections 141 and 142 elastically engaged with the corresponding hooks 114 and 115. This is the end of the attachment of the small shield cover 140.

When the second circuit board 135 is fitted instead of the first circuit board 130, the second circuit board 135 is fitted as follows. First, one edge of the second circuit board 135 is made to make contact with the hooks 113, whereby it is engaged with the engaging projections of the hooks 113, and then the other edge is pressed down. This makes the hooks 114 inserted into the notches 136, whereby the engaging projections thereof are engaged with the edges of the notches 136 as shown in FIG. 11. As a result, the second circuit board 135 is locked so as not to come out of position. This is the end of the fitting of the second circuit board 135.

After the second circuit board 135 is fitted, the opening in the upper face of the cabinet 110 is completely covered with a large shield cover 145 as shown in FIG. 12. The large shield cover 145 is made of stamped sheet metal, and has a hung projection 146 formed around the perimeter thereof in such a way that the cabinet 10 is surrounded thereby. The hung projection 146 has hooks 147 that are combined with the hooks 115 in place of the hung projections 142 of the small shield cover 140, and holes that are engaged with engaging projections 121 formed in the region of the frame 111 that is not covered with the small shield cover 140. When the large shield cover 145 is put on the cabinet 110 and then pressure is applied thereon, the elasticity of the sheet metal makes the hung projection 146 elastically engaged with the hooks 115 and the engaging projections 121. This is the end of the attachment of the large shield cover 145.

In the second embodiment, one first circuit board 130 and one second circuit board 135 are used; however, it is also possible to use a plurality of first circuit boards 130, a plurality of second circuit boards 135, or a plurality of first circuit boards 135 and a plurality of second circuit boards 135.

Both the first and second embodiments deal with cases where a hook is provided in a member (a liquid crystal display panel) accommodated in a cabinet for fitting a circuit board to the member. It is to be understood, however, that the present invention may be so implemented, for a display device in which a member other than a circuit board is not accommodated in a cabinet, or a display device in which a circuit board is first fitted inside a cabinet and then other member is put therein, that a hook protruding from the inner face of the cabinet is provided.

Incidentally, as display means, a flat display such as a plasma display can be selected instead of a liquid crystal display panel.

Obviously, many modifications and variations of the present invention are possible in light of the above teachings. It is therefore to be understood that within the scope of the appended claims, the invention may be practiced other than as specifically described.

### INDUSTRIAL APPLICABILITY

The present invention finds wide application in display devices in general that are formed by fitting a circuit board inside a cabinet and then covering an opening of the cabinet with a shield cover.

1. A display device comprising:
a flat box-shaped cabinet having a display member at a front side thereof and an opening at a back side thereof;
a circuit board that is fitted to the cabinet or a member accommodated inside the cabinet; and
a shield cover for covering the opening of the cabinet after the circuit board is fitted, wherein
the circuit board includes a first circuit board, fitting of which is compulsory, and a second circuit board, fitting of which is optional,
inside the cabinet, an area for the first circuit board and an area for the second circuit board are provided so as to be adjacent to each other,
a hook is formed in a boundary between these areas, and
when the second circuit board is not fitted, the hook is used for attaching a small shield cover that covers the first circuit board, and, when the second circuit board is fitted, the hook is used for locking the second circuit board in place.

2. A display device comprising:
a flat box-shaped cabinet having a display member at a front side thereof and an opening at a back side thereof;
a circuit board that is fitted to the cabinet or a member accommodated inside the cabinet; and
a shield cover for covering the opening of the cabinet after the circuit board is fitted, wherein
either a first circuit board or a second circuit board, a former is smaller than a latter, is selectively fitted as the circuit board, and
inside the cabinet, there is provided a hook that is used, when the first circuit board is fitted, for attaching a small shield cover that covers the first circuit board, and, when the second circuit board is fitted, for locking the second circuit board in place.

3. The display device of claim 1 or 2, wherein
display means is a liquid crystal display panel, the first circuit board is a driving circuit board, and the second circuit board is an inverter circuit board.
